(19) United States
(12) Patent Application Publication
(10) Pub. No.: US 2023/0094316 A1
(43) Pub. Date: Mar. 30, 2023

(54) COMPOSITION HAVING POLYOL AND ISOCYANATE

(71) Applicant: Dow Global Technologies LLC, Midland, MI (US)

(72) Inventors: Yinzhong Guo, Pearland, TX (US); Brian Dorvel, Missouri City, TX (US); Jingwei Fan, Pearland, TX (US); Qichun Wan, Midland, MI (US); Tuoqi Li, Dallas, TX (US)

(21) Appl. No.: 17/997,685

(22) PCT Filed: Apr. 23, 2021
(86) PCT No.: PCT/US2021/028755

§ 371 Date: Nov. 1, 2022

Related U.S. Application Data
(60) Provisional application No. 63/037,055, filed on Jun. 10, 2020.

(51) Int. Cl. C09D 175/14; C08G 18/42; C08G 18/71

(52) U.S. Cl. CPC C09D 175/14; C08G 18/4216; C08G 18/71

(57) ABSTRACT

Provided is a composition comprising one or more multifunctional isocyanate compounds and one or more polyols having a specified structure. Also provided is a method of adhering a first substrate to a second substrate to form an assembled article, wherein the method comprises the steps of applying a layer of the composition to a first surface of the first substrate and then bringing the layer of the composition into contact with a first surface of the second substrate. Also provided is an assembled article made by that method.

One important use of adhesive compositions is to use them as laminating adhesives, which bind together two films. The bound-together films may be useful for many purposes, for example in flexible packaging. It is desirable for adhesive compositions to have one or more of the following characteristics: good adhesion to polar substrates, such as, for example, polyester films; good adhesion to metal substrates such as, for example, metal foil or metallized polymer films; resistance to flex cracking; barrier properties to inhibit passage of one or more of oxygen, water, or carbon dioxide; increasing the curing rate while maintaining a balance with pot life; resistance to debonding when used as a boil-in-bag; and thermal stability. It is also desirable for some or all of the ingredients used in making the adhesive to be derived from sustainable natural sources.

US 2017/0058119 discloses a furan-based polyester that is the reaction product of 2,5-furandicarboxylic acid (FDCA) and a diol.

It is desired to provide an adhesive composition that has one or more of the desirable characteristics listed above and that is derived from biological sources.

The following is a statement of the invention.

A first aspect of the present invention is a composition comprising one or more multifunctional isocyanate compounds and one or more polyols having structure (I)

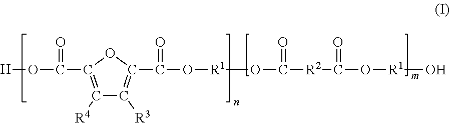

wherein each of R¹ and R² is an organic group; wherein each of R³ and R⁴ is either an organic group, a halogen atom, or a hydrogen atom; wherein n is 1 to 5,000; and wherein m is 0 to 5,000, and wherein R² does not have the structure II

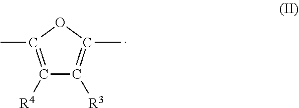

A second aspect of the present invention is a method of adhering a first substrate to a second substrate, wherein the method comprises the steps of applying a layer of the composition of the first aspect of the present invention to a surface of the first substrate and then bringing the layer of the composition of the first aspect of the present invention into contact with a surface of the second substrate.

A third aspect of the present invention is a bonded article formed by the method of the second aspect of the present invention.

A fourth aspect of the present invention is a composition comprising one or more multifunctional carboxylic acid compounds and one or more polyols having structure (I)

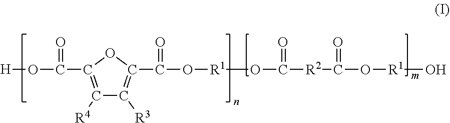

wherein each of R¹ and R² is an organic group; wherein each of R³ and R⁴ is either an organic group, a halogen atom, or a hydrogen atom; wherein n is 1 to 5,000; and wherein m is 0 to 5,000, and wherein R² does not have the structure II

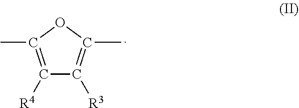

A fifth aspect of the present invention is a method of coating a substrate to form a coated article, wherein the method comprises the step of applying a layer of the composition of the fourth aspect to a surface of the substrate.

The following is a detailed description of the invention.

As used herein, the following terms have the designated definitions, unless the context clearly indicates otherwise.

As used herein, an organic group is a group of atoms that are connected to each other through covalent bonds and that contain one or more carbon atoms. As used herein, a “substituted” organic group is an organic group having one or more substituent. Substituents may be, for example, halogens, hydrocarbon groups, hydroxyl groups, amine groups, carboxyl groups, or combinations thereof.

As used herein, an ester linkage is a group having structure (III):

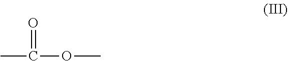

A compound having three or more ester linkages is a polyester.

As used herein an ether linkage has the structure —O—, where the oxygen atom is connected to two carbon atoms, and the ether linkage is not part of an ester linkage. An ether group has the structure IV

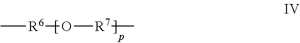

where each of R⁶ and R⁷ is, independently, a substituted or unsubstituted alkyl group, where the various R⁷ groups may be the same as each other or different from each other, and where p is 1 or more. When R⁶ and every R⁷ is an unsubstituted alkyl group, the ether group is an unsubstituted ether group. A compound having three or more ether linkages is a polyether.

As used herein, a polyol is a compound having two or more hydroxyl groups, and a diol is a polyol having exactly two hydroxyl groups. A triol is a polyol having exactly three hydroxyl groups. A polyol that is also a polyether is a polyether polyol. A polyol that is also a polyester is a polyester polyol.

As used herein, a multifunctional isocyanate compound is a compound having two or more isocyanate groups. A multifunctional isocyanate compound having exactly two isocyanate groups is a diisocyanate, and a multifunctional isocyanate compound having exactly three isocyanate groups is a triisocyanate.

A blocked multifunctional isocyanate compound is a multifunctional isocyanate compound in which one or more of the isocyanate groups has been reacted with a blocking compound to form a metastable product. This metastable product, at temperatures slightly above room temperature (23° C.), typically at 40° C. to 80° C., decomposes to recreate the isocyanate groups, which are then available to react with hydroxyl groups.

As used herein, a urethane linkage is a group having structure (V)

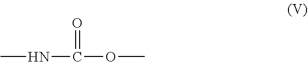

As used herein, a urea linkage is a group having structure (VI)

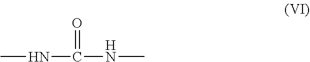

As used herein, a multifunctional isocyanate monomer is a multifunctional isocyanate compound having molar mass of 800 g/mol or less. A multifunctional isocyanate monomer having exactly two isocyanate groups is a diisocyanate monomer. As used herein, a multifunctional isocyanate prepolymer is a multifunctional isocyanate compound having molar mass greater than 800 g/mol and having two or more groups that are chosen from urethane linkages or urea linkages or a mixture thereof.

The acid value (AV) of a compound is determined by ASTM 974 (American Society of Testing and Materials, West Conshohocken, PA, USA), and is reported in units of mg of KOH per gram of compound. The hydroxyl value (also called OH number, or OHN, OH# ) of a compound is determined by ASTM 4274 (American Society of Testing and Materials, West Conshohocken, Pa., USA), and is reported in units of mg of KOH per gram of compound.

A multifunctional carboxylic acid compound is a compound having two or more carboxylic acid groups. Each carboxylic acid group may independently be in protonated form or in anionic form. Anyhdride compounds are considered to be multifunctional carboxylic acid compounds.

The molecular weight of a polymeric material is characterized herein using size exclusion chromatography (SEC) by Mn, the number-average molecular weight, or by Mw, the weight-average molecular weight. Mn and Mw are reported in units of g/mol or, equivalently, Daltons. The NCO % of a compound is the weight of all isocyanate groups in that compound, as a percentage of the total weight of the compound, and NCO % is assessed by ASTM D2572.

As used herein, a solvent is a composition that is liquid at 25° C. and that has boiling point of 150° C. or lower.

In a composition that contains isocyanate groups and groups selected from hydroxyl groups, amine groups, and mixtures thereof, the isocyanate index is the ratio of the moles of isocyanate groups to the sum of the moles of hydroxyl groups plus the moles of amine groups.

As used herein, a film is an object that is solid over a temperature range that includes 0° C. to 40° C. One dimension of a film is 1 mm or less, and the other two dimensions are each 5 cm or larger. The dimension that is 1 mm or less is known as the thickness of the film, and the two surfaces that are perpendicular to the thickness are known as the faces of the film.

The present invention involves a composition that contains one or more polvols having the structure I

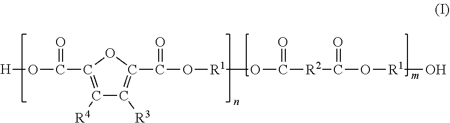

wherein each of R¹ and R² is an organic group; wherein each of R³ and R⁴ is either an organic group, a halogen atom, or a hydrogen atom; wherein n is 1 to 5,000; and wherein m is 0 to 5,000, and wherein R² does not have the structure II

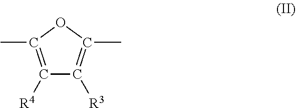

The left-hand bracket, which has subscript n, denotes n units, so there are n occurrences of the group R¹. When n is larger than 1, each of the various R¹ groups in the left-hand bracket may be the same as each other or different from any of the other R¹ groups in the left-hand bracket. Further, when m is 2 or greater, the each of the various R¹ groups in the right-hand bracket may be the same as or different from any of the other R¹ groups in the right-hand bracket. Similarly, when m is 1 or greater, the various R¹ groups in the right-hand bracket may be the same as or different from any of the R¹ groups in the left-hand bracket. Also, when m is 2 or greater, the each of the various R² groups may be the same as or different from any of the other R² groups.

R³ and R⁴ may be the same as each other or different from each other. When n is larger than 1, each of the various R³ groups in the left-hand bracket may be the same as each other or different from any of the other R³ groups in the left-hand bracket, and each of the various R⁴ groups in the left-hand bracket may be the same as each other or different from any of the other R⁴ groups in the left-hand bracket.

R¹ groups may be linear, branched, cyclic, or a combination thereof. R¹ groups may optionally contain one or more ester linkages, one or more ether linkages, or a combination thereof. R¹ groups may optionally contain one or more hydroxyl groups. R² groups may be linear, branched, cyclic, or a combination thereof. R² groups may optionally contain one or more ester linkages, one or more ether linkages, or a combination thereof. R² groups may optionally contain one or more carboxyl groups.

Preferred R¹ groups are substituted alkyl groups, unsubstituted alkyl groups, substituted ether groups, unsubstituted ether groups, and mixtures thereof; more preferred are unsubstituted alkyl groups, unsubstituted ether groups, and mixtures thereof. Ether groups are defined in structure (IV), above. Among ether groups, preferably p is 3 or lower; more preferably 2 or lower; more preferably 1. Preferred R¹ groups have 2 or more carbon atoms. Preferred R¹ groups have 20 or fewer carbon atoms; more preferably 15 or fewer carbon atoms; more preferably 10 or fewer carbon atoms; more preferably 8 or fewer carbon atoms.

Preferred R² groups are substituted and unsubstituted alkyl groups; more preferred are unsubstituted alkyl groups. Preferred R² groups have 2 or more carbon atoms; more preferably 3 or more carbon atoms. Preferred R² groups have 20 or fewer carbon atoms; more preferably 15 or fewer carbon atoms; more preferably 10 or fewer carbon atoms; more preferably 6 or fewer carbon atoms.

Preferred R³ and R⁴ groups are hydrogen atoms or unsubstituted alkyl groups. Preferred R³ and R⁴ groups have 4 or fewer carbon atoms; more preferably 3 or fewer carbon atoms; more preferably 2 or fewer carbon atoms; more preferably R³ and R⁴ groups either have exactly 1 carbon atom or else are hydrogen atoms; more preferably R³ and R⁴ are hydrogen atoms.

In structure (I), n is 5,000 or less; preferably 3,500 or less; more preferably 2,500 or less. In structure (I), preferably n is 10 or more; more preferably 50 or more; more preferably 100 or more; more preferably 200 or more; more preferably 500 or more. In structure (I), preferably m is 1 or more; more preferably 10 or more; more preferably 50 or more; more preferably 100 or more; more preferably 200 or more; more preferably 500 or more. In structure (I), m is 5,000 or less. Preferably, m is 3,500 or less; more preferably 2,500 or less.

Preferably, the polyol of structure (I) has Mn of 400 g/mol or higher; more preferably 800 g/mol or higher. Preferably, the polyol of structure (I) has Mn or 20,000 g/mol or lower; more preferably 10,000 or lower; more preferably 7,000 or lower; more preferably 4,000 or lower. Preferably, the polyol of structure (I) has hydroxyl value of 25 mg KOH/g or higher; more preferably 40 mg KOH/g or higher. Preferably, the polyol of structure (I) has hydroxyl value of 500 mg KOH/g or lower; more preferably 200 mg KOH/g or lower. Preferably, the polyol of structure (I) has acid value of 0 to 10 mg KOH/g; more preferably 0 to 6 mg KOH/g; more preferably 0 to 3 mg KOH/g.

The composition of the present invention optionally contains one or more solvents. Preferably, the amount of solvent, by weight, based on the weight of the composition of the present invention, is 20% or more; more preferably 40% or more; more preferably 60% or more. Preferably, the amount of solvent, by weight, based on the weight of the composition of the present invention, is 85% or less; more preferably 75% or less. Solvent may be a single compound or may be a mixture of two or more compounds.

When the composition contains a solvent, a suitable solvent is any organic compound that will dissolve the materials of the composition. Preferred are solvents in which the molecules contains one or more oxygen atom or one more halogen atom. Examples of preferred solvents are ethyl acetate, methyl ethyl ketone (MEK), methyl butyl ketone, and chloroform. Mixtures of two or more suitable solvents are also suitable, as long as the various solvents are soluble in each other at the proportions used.

The composition optionally contains one or more additional ingredients, for example, one or more defoamers, one or more levelling agents, one or more wetting agents, one or more catalyst, one or more further ingredients, and mixtures thereof.

The following discussion, until otherwise stated, pertains to the first, second, and third aspects of the present invention.

In the first, second, and third aspects, the present invention involves a composition that contains one or more multifunctional isocyanate compounds. Multifunctional isocyanate compounds may be multifunctional isocyanate prepolymers, multifunctional isocyanate monomers, or mixtures thereof. Preferably, one or more multifunctional isocyanate monomers are used. Preferred multifunctional isocyanate monomers are diisocyanate monomers, cyclic dimers (also called uretdiones) of diisocyanate monomers, cyclic trimers (also called isocyanurates) of diisocyanate monomers, and mixtures thereof. In some optional embodiments, one or more multifunctional isocyanate compounds are used that are blocked multifunctional isocyanate compounds.

The composition of the present invention contains both one or more multifunctional isocyanate compounds and one or more polyols of structure (I). The isocyanate index of the composition of the present invention is preferably 0.9 or higher; more preferably 1.0 or higher; more preferably 1.05 or higher. The isocyanate index of the composition of the present invention is preferably 2.0 or lower; more preferably 1.5 or lower.

Preferably, all of the materials in the composition of the present invention other than solvent are dissolved in the solvent to form a solution.

Preferably, the sum of all compounds other than solvents, polyols, polyamines, and isocyanate compounds is, by weight based on the weight of the composition of the present invention, 0 to 25%; more preferably 0 to 10%; more preferably 0 to 5%; more preferably 0 to 2%; more preferably 0 to 1%.

The composition of the present invention optionally additionally contains one or more additional compounds (“HA compounds”) selected from one or more polyols other than polyols of structure (I), one or more polyamines, or a mixture thereof. Among HA compounds, polyols other than polyols of structure (I) are preferred. Preferably, the amount of HA compounds, by weight based on the total weight of the adhesive composition, is 0 to 40%; more preferably 0 to 20%; more preferably 0 to 10%; more preferably 0 to 5%; more preferably 0 to 2%; more preferably 0 to 1%. In some embodiments, the composition of the present invention contains no HA compounds.

In preferred embodiments, herein called “two-pack” embodiments, the composition of the present invention exists in two separate containers, herein labeled “Pack A” and “Pack B.” Pack A contains one or more multifunctional isocyanate compounds. Pack B contains one or more polyols of structure (I). Preferably, Pack A either contains zero polyols or else, if any polyols are present in Pack A, the total amount of polyols in Pack A, by weight based on the weight of Pack A, is 5% or less; more preferably 2% or less; more preferably 1% or less; more preferably 0.5% or less. Preferably, Pack B either contains zero multifunctional isocyanate compounds or else, if any multifunctional isocyanate compounds are present, the total amount of all multifunctional isocyanate compounds in Pack B is, by weight based on the weight of Pack B, 5% or less; more preferably 2% or less; more preferably 1% or less; more preferably 0.5% or less.

It is contemplated that when Pack A is mixed with Pack B, the hydroxyl groups and isocyanate groups will begin to react. Therefore it is contemplated that Pack A and Pack B will be mixed together a relatively short time prior to applying the mixture to a surface of a substrate.

Preferably the composition of the present invention is liquid at 25° C.

The composition of the present invention may be used for any purpose. A preferred purpose is to adhere two substrates to each other. Preferably a layer of the composition of the present invention is applied to a surface of a first substrate. The application may be made by any method. Preferably, subsequently, the layer of the composition of the present invention is brought into contact with a second substrate.

Preferred substrates are films. Preferred films are polymer films, metal films, metalized polymer films, and combinations thereof. Preferred films have thickness of 1 micrometer or more; more preferably 2 micrometer or more; more preferably 5 micrometer or more. Preferred films have thickness of 200 micrometer or less; more preferably 100 micrometer or less.

Preferred films are polymeric films, metal films (also called foils), polymeric films with a metal coating (also called metallized films), and combinations thereof. Preferably, one or more of the film surfaces that are in contact with the layer of the composition of the present invention are metal. The metal surface may be either the metal surface of a metallized film or one surface of a metal foil. Examples of suitable metallized films are metallized polyester film, metallized polypropylene film, and metallize polyethylene film.

Preferably, a layer of the composition of the present invention is applied to a first face of a first film, and solvent, if present, is caused to evaporate or is allowed to evaporate. The evaporation of solvent, if performed, may be performed at room temperature (approximately 23° C.), or the layer of the composition of the present invention may be exposed to higher temperatures, for example in an oven. Preferably, the applying and evaporating are performed quickly enough and/or at low enough temperature that 50 mole % or more of the hydroxyl groups remain as hydroxyl groups and have not reacted with isocyanate groups. Then, preferably, the layer of the composition of the present invention is brought into contact with the first face of a second substrate.

Then, preferably, the assembled article comprising the first substrate, the layer of the composition of the present invention, and the second substrate is subjected to force that presses the two substrates together and/or subjected to elevated temperature. When the substrates are films, such a process of forcing the substrates together is known as lamination. Lamination may be performed at room temperature or at elevated temperatures. Typical elevated temperatures for lamination are 45° C. to 60° C. Then, preferably, the assembled article remains for sufficiently long time and/or is subjected to sufficiently high temperature that 80 mole % or more of the isocyanate groups have reacted to form urethane linkages, urea linkages, or a mixture thereof.

The assembled article may be used for any purpose. For example, the assembled article, possibly after being laminated to additional polymer layers, may be formed into a flexible package. Such flexible packages may be used to contain any type of product, including, for example, food, including, for example, dry food or liquid food, and including, for example, food containing fat or food that does not contain fat. In some embodiments, the flexible package has the form of a bag. Some of such bags are used as “boil-in-bags,” which are bags that contain food and that are intended to be exposed to sterilization conditions and/or high temperature conditions of 100° C. or above. For examples, many “boil-in-bags” allow for the heating of the food inside the bag by placing the bag in boiling water. It is desirable that the material forming such a bag maintains its mechanical strength when subjected to any of these sterilization and/or high-temperature conditions.

The following discussion, until otherwise stated, pertains to the fourth and fifth aspects of the present invention.

In the fourth and fifth aspect of the present invention, the composition contains one or more multifunctional carboxylic acid compounds. Suitable multifunctional carboxylic acid compounds include those, for example, having structure HOOC—R²-COOH, where the suitable and preferred versions of R² are described above. Also suitable are polymers having Mn of 1,000 and having or more carboxylic acid groups per molecule.

In some embodiments, the composition of the fourth aspect is a two pack composition, with the packs herein labeled pack C and Pack D. Pack C contains one or more multifunctional carboxylic acid compounds. Pack C contains polyol of structure (I) in an amount, by weight based on the weight of pack C, of 0 to 2%; more preferably 0 to 1%; more preferably 0%. Pack D contains one or more polyol of structure (I). Pack D contains multifunctional carboxylic acid compound in an amount, by weight based on the weight of pack D, of 0 to 2%; more preferably 0 to 1%; more preferably 0%.

The composition of the fourth aspect may be used for any purpose. In a preferred embodiment (i.e., the fifth aspect of the invention), the composition is used as a coating. That is, a layer of the composition is applied to a surface of a substrate, and any solvent in that layer of the composition is caused to evaporate or allowed to evaporate. The evaporation of solvent, if performed, may be performed at room temperature (approximately 23° C.), or the layer of the composition of the present invention may be exposed to higher temperatures, for example in an oven.

In the fifth aspect of the present invention, the composition optionally includes one or more pigment. Suitable pigments are nonreactive materials in the form of particles of average diameter of 5 micrometer or less. Pigments may be organic polymers or inorganic compounds. Suitable pigments include, for example, polymeric particles, titanium dioxide, other oxides, clay, calcium carbonate, and mixtures thereof. When pigment is present, the preferred total amount of pigment is, by weight based on the weight of the composition, 20% or more; more preferably 30% or more. When pigment is present, the preferred total amount of pigment is, by weight based on the weight of the composition, is 60% or less; more preferably 50% or less.

When pigment is present, it is expected that the pigment will not be dissolved in the composition of the present invention, whether or not solvent is present. When pigment is present, it is envisioned that one or more dispersant is also present. A dispersant resides at the surface of a pigment particle and assists in keeping pigment particles distributed throughout the composition. Preferably, all ingredients in the composition other than pigments and dispersants are dissolved in each other to form a solution.

Preferably, in embodiments of the fifth aspect of the present invention, the total amount of solvent, multifunctional carboxylic acid compounds, polyols of structure (I), other polyols, and pigments, is by weight based on the weight of the composition, 60% or more; more preferably 75% or more; more preferably 90% or more; more preferably 95% or more.

The composition optionally contains one or more additional ingredients, for example, one or more defoamers, one or more levelling agents, one or more wetting agents, one or more catalyst, one or more further ingredients, and mixtures thereof.

The following are examples of the present invention. The examples illustrate the first, second, and third aspects of the present invention. Operations were performed at room temperature (approximately 23° C.) except where otherwise stated. “Ambient conditions” means room temperature.

The raw materials that were used to synthesize the polyester polyols and to prepare the compositions described in the examples are summarized below:
Adipic acid (AA), 1,6-hexanediol (HDO), 1,4-butanediol (BDO), titanium isopropoxide, and stannous chloride were purchased from Sigma Aldrich and used as received.
2,5-furandicarboxylic acid (FDCA) was purchased from Ningbo Jisu New Materials Technology Co. Ltd, China and used as received.
Aliphatic multifunctional isocyanate compound Mor-FreeTM C-33, from Dow Chemical and used as received.
Incumbent barrier adhesive formulation, containing polyester polyol different from the present invention, ADCOTE™ L86-500, from Dow Chemical and used as received.
Flow modifier MODAFLOWTM liquid were from Dow Chemical and used as received.

BDO-FDCA: polyester polyol was prepared as follows:

| Item | Monomer/Intermediate | Charge (g) |
|---|---|---|
| 1 | 1,4-Butanediol | 450.7 |
| 2 | 2,5-Furandicarboxylic acid | 640.0 |
| 3 | Stannous Chloride | 0.053 |

A 3L multi-neck round bottom flask was dried in an oven, and then charged with Items 1 and 2 under ambient conditions. The system was pulled vacuum to about 90 mTorr and refilled with nitrogen. After 4 cycles of vacuum/N₂, the reactor was left under continuous N₂ flow, and slowly heated up. Once the reactor temperature reached 100° C., the overhead mechanical agitator was slowly turned on for stirring the mixture. The reaction temperature was then increased to 150, 170, 190, 200° C. gradually and held at 200° C., when about 50% of the theoretical water evolved, the acid value (AV) and in-process viscosity were monitored. The reaction mixture did not become homogeneous and turned to dark colored paste after about 2 h at 200° C. The reactor was maintained at 200° C. until AV was less than 10 mg KOH/g, then Item 3 was added, the resin mixture was maintained at 195-200° C. and 550-650 mTorr vacuum for 2 h. The total cycle time was about 10 h. Then, the resin was cooled to about 160° C., transferred, and packaged.

The final product easily crystallized as rigid solids at lower temperatures and was not soluble in any common organic solvent, except for hexafluoro-2-propanol (HFIP). Therefore, the properties were not measurable via standard characterization techniques.

HDO-FDCA-AA-1: polyester polyol was prepared as follows:

| Item | Monomer/Intermediate | Charge (g) |
|---|---|---|
| 1 | 1,6-hexanediol | 516.6 |
| 2 | 2,5-Furandicarboxylic acid | 175.1 |
| 3 | Adipic Acid | 260.4 |
| 4 | Titanium Isopropoxide | 0.78 |

A 3L multi-neck round bottom flask was dried in an oven, and then charged with Item 1 through 3 under ambient conditions. The system was pulled vacuum to about 90 mTorr and refilled with nitrogen. After 4 cycles of vacuum/N₂, the reactor was left under continuous N₂ flow, and slowly heated up with overhead agitation. The reaction temperature was first increased to 150° C. and held at 150° C. for 0.5 h, then to 160° C. for 0.5 h, followed by 0.5 h at 170° C. and 180° C., respectively. Finally, the reactor temperature was held at 190° C. When about 50% of the theoretical water evolved, the acid value (AV) and in-process viscosity were monitored. The reaction mixture became clear and homogeneous after 4 h at 190° C., but turned to dark brown color after about 1 h at 190° C. The reactor was maintained at 190° C. until AV was less than 10 mg KOH/g, then Item 4 was added, the resin mixture was maintained at 185-190° C. for lh prior to being pulled vacuum to 550-650 mTorr vacuum for 2 h. The total cycle time was about 15 h. Then, the resin was cooled to about 160° C., transferred and packaged.

The final product had the following properties: Acid Value 0.98 mg KOH/g; OH Number 177 mg KOH/g; Viscosity at 60° C. 401 cPs; Mₙ 920 g/mol; M_{w} 1943 g/mol; polydispersity (M_{w}/Mₙ) 2.11. This resin also crystallized as semi-solids under ambient conditions, but was easily dissolved in common organic solvents (MEK, ethyl acetate, chloroform, etc.). Therefore, the size exclusion chromatography (SEC) analysis was successfully performed at 40° C. with chloroform as the mobile phase.

HDO-FDCA-AA-2: polyester polyol was prepared as follows:

| Item | Monomer/Intermediate | Charge (g) |
|---|---|---|
| 1 | 1,6-hexanediol | 709.4 |
| 2 | 2,5-Furandicarboxylic acid | 616.8 |
| 3 | Adipic Acid | 153.9 |
| 4 | Titanium Isopropoxide | 1.5 |

A 3L multi-neck round bottom flask was dried in an oven, and then charged with Item 1 through 3 under ambient conditions. The system was pulled vacuum to about 90 mTorr and refilled with nitrogen. After 4 cycles of vacuum/N₂, the reactor was left under continuous N₂ flow, and slowly heated up with overhead agitation. The reaction temperature was first increased to 150° C. and held at 150° C. for 0.5 h, then to 160° C. for 0.5 h, followed by 0.5 h at 170° C. and 180° C., respectively. Finally, the reactor temperature was held at 190° C. When about 50% of the theoretical water evolved, the acid value (AV) and in-process viscosity were monitored. The reaction mixture became clear and homogeneous after 4 h at 190° C., but turned to dark brown color after about 1 h at 190° C. The reactor was maintained at 190° C. until AV was less than 10 mg KOH/g, then Item 4 was added, the resin mixture was maintained at 190° C. for lh prior to being pulled vacuum to 550-650 mTorr vacuum for 2 h. The total cycle time was about 13 h. Then, the resin was cooled to about 160° C., transferred and packaged.

The final product has the following properties: Acid Value 2.3 mg KOH/g; OH Number 62 mg KOH/g; Mn 1692 g/mol; Mw 4628 g/mol; polydispersity (Mw/Mn) 2.74. This resin easily crystallized as solids under ambient conditions, and was able to dissolve in common organic solvents (MEK, chloroform, and ethyl acetate) at elevated temperatures >50° C., but the solids precipitated out as the solution cooled down. For the SEC samples, they were stable over time since the resin was dissolved in chloroform at low concentrations.

HDO-FDCA-AA-3: polyester polyol was prepared as follows:

| Item | Monomer/Intermediate | Charge (g) |
|---|---|---|
| 1 | 1,6-hexanediol | 709.4 |
| 2 | 2,5-Furandicarboxylic acid | 469.2 |
| 3 | Adipic Acid | 299.9 |
| 4 | Titanium Isopropoxide | 1.28 |

A 3L multi-neck round bottom flask was dried in an oven, and then charged with Item 1 through 3 under ambient conditions. The system was pulled vacuum to about 90 mTorr and refilled with nitrogen. After 4 cycles of vacuum/N₂, the reactor was left under continuous N₂ flow, and slowly heated up with overhead agitation. The reaction temperature was first increased to 150° C. and held at 150° C. for 0.5 h, then to 160° C. for 0.5 h, followed by 0.5 h at 170° C. and 180° C., respectively. Finally, the reactor temperature was held at 190° C. When about 50% of the theoretical water evolved, the acid value (AV) and in-process viscosity were monitored. The reaction mixture became clear and homogeneous after 4 h at 190° C., but turned to dark brown color after about lh at 190° C. The reactor was maintained at 190° C. until AV was less than 10, then Item 4 was added, the resin mixture was maintained at 190° C. for lh prior to being pulled vacuum to 550-650 mTorr vacuum for 2 h. The total cycle time was about 18 h. Then, the resin was cooled to about 160° C., transferred and packaged.

The final product has the following properties: Acid Value 1.2 mg KOH/g; OH Number 71 mg KOH/g; Mn 1968 g/mol; Mw 5040 g/mol; polydispersity (Mw/Mn) 2.56. This resin easily crystallized as solids under ambient conditions, and was able to dissolve in common organic solvents (MEK, chloroform, and ethyl acetate) at elevated temperatures approximately 40 to 50° C., but the solids precipitated out as the solution cooled down to room temperature. For the SEC samples, they were stable over time since the resin was dissolved in chloroform at low concentrations.

DEG-IA-AA: polyester polyol (without FDCA) was prepared as follows:

| Item | Monomer/Intermediate | Charge (g) |
|---|---|---|
| 1 | Diethylene Glycol | 522.2 |
| 2 | Isophthalic Acid | 326.9 |
| 3 | Adipic Acid | 326.9 |
| 4 | Tetra-n-butyl Titanate | 0.014 |

Charged Items 1 and 2 to the reactor at ambient temperature (approximately 25-30° C.). The reaction mixture was heated slowly to 100° C. under Nitrogen with stirring. The reaction temperature was then increased to 225° C. and held at 225° C., when approximately 50% of theoretical water evolved the AV and In-Process viscosity were monitored. The reactor was maintained at 225° C. until AV was less than approximately 30 mg KOH/g. The resin was cooled to approximately 125° C. and then Item 3 was added, the resin mixture was maintained at 125-130° C. for 0.50 Hrs. The reactor temperature was slowly increased to 225° C. and then maintained at 225° C., until AV was less than 10 mg KOH/g. Item 4 was added and vacuum at approximately 435 mm Hg was applied as needed to decrease AV to final target property. The AV and In-Process Viscosity were monitored; reaction is maintained at 225° C. until AV was less than approximately 1 mg KOH/g. Cooled resin to about 150° C., filtered and packaged.

The final resin had the following properties: Acid Value (AV) 0.5 mg KOH/g; OH Number 66 mg KOH/g, Viscosity at 50° C. of 6,525 mPa·s.

HDO-FDCA-EDG-AA-1: polyester polyol was prepared as follows:

| Item | Monomer/Intermediate | Charge (g) |
|---|---|---|
| 1 | Ethylene Glycol | 16.8 |
| 2 | Hexane Diol | 24.1 |
| 3 | Adipic Acid | 41.1 |
| 4 | 2,5-Furandicarboxylic acid | 17.7 |
| 5 | Tin Chloride dihydrate | 0.02 |

The acid and diol were weighed into a flask. The flask was placed into an oil bath, degassed by pulling a vacuum. After 4 cycles of vacuum/N₂ purging, the reactor was left under continuous N₂ flow, and slowly heated up. Once the reactor temperature reached 100° C., the overhead mechanical stirring was turned on slowly. The reaction temperature was then gradually increased to 200° C. by 10° C. per every 30 minutes, then held at 200° C. The reactor was maintained at 200° C. until the acid number was less than 10 mgKOH/g, then the catalyst Tin Chloride dihydrate (at 0.01%-0.02% by weight of total reaction weight) was added, the resin mixture was maintained at 195-200° C. under vacuum for 2-4 hours, until acid number was less than 1mg KOH/g. The total cycle time was about 20-40 hrs. The produced polyester was cooled to about 160° C., transferred and packaged. Since the acid number was low, the majority polyester end groups were hydroxyl. These polyesters were also called polyester polyols. OH# : 110 mgKOH/g, AV: approximately 0.7 mgKOH/g, Mn: 3117 g/mol, MW: 7507g/mol.

HDO-FDCA-EDG-AA-2: polyester polyol was prepared as follows:

| Item | Monomer/Intermediate | Charge (g) |
|---|---|---|
| 1 | Ethylene Glycol | 16.8 |
| 2 | Isophthalic Acid | 24.0 |
| 3 | Adipic Acid | 35.5 |
| 4 | 2,5-Furandicarboxylic acid | 23.7 |
| 5 | Tin Chloride dihydrate | 0.02 |

The acid and diol were weighed into a flask. The flask was placed into an oil bath, degassed by pulling a vacuum. After 4 cycles of vacuum/N₂ purging, the reactor was left under continuous N₂ flow, and slowly heated up. Once the reactor temperature reached 100° C., the overhead mechanical stirring was turned on slowly. The reaction temperature was then gradually increased to 200° C. by 10° C. per every 30 minutes, then held at 200° C. The reactor was maintained at 200° C. until the acid number was less than 10 mgKOH/g, then the catalyst Tin Chloride dihydrate (at 0.01%-0.02% by weight of the total reaction weight) was added, the resin mixture was maintained at 195-200° C. under vacuum for 2-4 hours, until acid number was less than 1 mgKOH/g. The total cycle time was about 20-40 hrs. The produced polyester was cooled to about 160° C., transferred and packaged. Since the acid number was low, the majority polyester end groups were hydroxyl. These polyesters were also called polyester polyols. OH# : 98 mgKOH/g, AV: 0.6 mgKOH/g:, Mn: 2793 g/mol, MW: 6596 g/mol.

HDO-AA polyester polyol (without FDCA) was prepared as follows:

| Item | Monomer/Intermediate | Charge (g) |
|---|---|---|
| 1 | Hexane diol | 51.5 |
| 3 | Adipic Acid | 48.5 |
| 4 | Tin Chloride dihydrate | 0.02 |

The acid and diol were weighed into the flask. The flask was placed into an oil bath, degas sed by pulling a vacuum. After 4 cycles of vacuum/N₂ purging, the reactor was left under continuous N₂ flow, and slowly heated up. Once the reactor temperature reached 100° C., the overhead mechanical stirring was turned on slowly. The reaction temperature was then gradually increased to 200° C. by 10° C. per every 30 minutes, then held at 200° C. The reactor was maintained at 200° C. until the acid number was less than 10 mgKOH/g, then the catalyst Tin Chloride dihydrate (at 0.01%-0.02% by weight of the total reaction weight) was added, the resin mixture was maintained at 195-200° C. under vacuum for 2-4 hours, until acid number was less than 1 mgKOH/g. The total cycle time was about 20-40 hrs. The produced polyester was cooled to about 160° C., transferred and packaged. Since the acid number was low, the majority polyester end groups were hydroxyl. These polyesters were also called polyester polyols. OH# : 112 mgKOH/g, AV: 0.17 mgKOH/g, Mn:1733 g/mol, MW: 4008 g/mol.

The following films were used:
BOPP: Bi-axially orientated polypropylene film, thickness 12 microns.
Metallized BOPP (met-BOPP): AET Film, metallized oriented polypropylene film, MT film, heat sealable, thickness 18 microns.
PRELAM: 12 micrometer (48 Gauge) Polyester (PET) Film laminated to 9 micrometer thick Al Foil with ADCOTE™ 545/Coreactant F at 3.26 g/m² (2.00 lbs/ream), available from Dow Chemical Company.
PE (GF-19): high slip low density polyethylene film, thickness 38.1 micrometer, available from Berry Plastics Corp.

The lamination procedures were as follows:

The polyester-polyol HDO-FDCA-AA-1 was first formulated with the MODAFLOW™ liquid and casting solvent Ethyl Acetate and then was mixed with the isocyanate coreactant Mor-Free™ C-33 at the ratios specified in Table 1. The mixture was then applied to a primary film, followed by laminating it with a secondary film using a Nordmeccanica Labocombi pilot laminator. For all formulations, the solids content was controlled at 30 to 45% during application. The Comparative Example 1 was prepared in a similar fashion.

The polyester-polyols HDO-FDCA-AA-2 and HDO-FDCA-AA-3 were first dissolved at a solids content of 25% in Chloroform, and the MODAFLOW™ liquid was then added. These solutions were premixed with designated amounts of the isocyanate coreactant Mor-FreeTM C-33 (See Table 1), and then the mixture was hand coated onto the primary film using a Meyer rod (# 6), followed by a drying step in an 80° C. oven for 1 min. The primary film with the adhesive was laminated to the secondary film on an oil-based laminator with nipping temperature set at 180° F. The coating weight was controlled at 4.4 to 4.7 g/m² (2.7-2.9 pounds/ream). At least five laminates 20.3 cm×27.9 cm (8×11 inch) were prepared for each formulation with bond strip within the laminate to facilitate bond strength testing. The as-prepared laminates were placed under weight of 0.45 to 0.91 kg (1-2 pound) in order to apply uniform pressure across the laminate sample. The Comparative Example 2 was prepared in a similar fashion except that ethyl acetate was employed as the casting solvent.

Bond strength between the two films was measured at various intervals of room temperature (approximately 23° C.) storage after the lamination. After 14 days, pouches were made using the laminate structure and filled with a 1:1:1 sauce (blend of equal parts by weight of ketchup, vinegar and vegetable oil) for boil-in-bag tests as described later.

Adhesive compositions were made according to the following tables:

TABLE 1A
Adhesive formulation compositions and characterization results
(“Ex” means “Example,” and “CE” means “Comparative Example”)

| Weight (g) | Ex 1 | Ex 2 | Ex 3 | CE 1 | CE 2 |
|---|---|---|---|---|---|
| ADCOTE ™ L86-500(*) | — | — | — | 2327 | — |
| MODAFLOW ® liquid | 6.5 | 0.07 | 0.08 | — | 0.08 |
| HDO-FDCA-AA-1 | 916.3 | — | — | — | — |
| HDO-FDCA-AA-2 | — | 10.5 | — | — | — |
| HDO-FDCA-AA-3 | — | — | 10.4 | — | — |
| DEG-IA-AA | — | — | — | — | 11.7 |
| Ethyl Acetate | 1695 | — | — | — | 35 |
| Chloroform | — | 31.9 | 32.3 | — | — |
| Mor-Free ™ C-33 | 434 | 2.9 | 3.3 | 419 | 3.3 |
| NCO index | 1.2 | 1.3 | 1.3 | 1.3 | 1.3 |
| Solids (%) | 45 | 30 | 30 | 45 | 32 |

(*)contains 35% ethyl acetate by weight

TABLE 1B
Adhesive formulation compositions

| Weight (gram) | Ex 4 | Ex 5 | CE 3 |
|---|---|---|---|
| HDO-FDCA-EDG-AA-1 | 20 | — | — |
| HDO-FDCA-EDG-AA-2 | — | 20 | — |
| HDO-AA | — | — | 20 |
| Ethyl Acetate | 70.2 | 67.7 | 70.6 |
| Mor-Free ™ C-33 | 10.3 | 10.1 | 9.0 |
| NCO index | 1.3 | 1.3 | 1.3 |
| ASTM Solids (%) | 30 | 30 | 30 |

Testing procedures were as follows.

Bond Strength Measurement: the 90° T-peel test was done on laminate samples cut to 2.54 cm (1 inch) wide strips and pulled on a Thwing Albert™ QC-3A peel tester equipped with a 50N loading cell at a rate of 25.4 cm/min (10 inch/min). When the two films in the laminate separated (peeled), the average of the force during the pull was recorded. If one of the films stretched or broke, the maximum force or force at break was recorded. The values represent the average over at least four identical strips for each sample. The failure mode (FM) or mode of failure (MOF) was recorded as below:
FS: Film Stretch
FT: Film Tears or Breaks
DL: Delaminated, the secondary film separated from the primary film
AT: Adhesive Transfer (adhesive fails to adhere to the primary film and is transferred to the secondary film).
AS: Adhesive Split or cohesive failure (adhesive is found on both primary and secondary film)

Boil-in-Bag Test Procedure: Laminates were made from the met-BOPP/BOPP and Prelam Al/GF-19 as described above. One of the 9″×12″ (23 cm×30.5 cm) sheets of laminate was folded over to give a double layer about 23 cm×15.3 cm (9″×6″) such that the polymer film of one layer was in contact with the polymer film of the other layer. The edges were trimmed on a paper cutter to give a folded piece about 12.7×17.8 cm (5″×7″). Two long sides and one short side was heat sealed at the edges to give a finished pouch with an interior size of 10.2 cm×15.2 cm (4″×6″). The heat sealing was done at 177° C. (350° F.) for 1 second at a hydraulic pressure of 276 kPa (40 psi). Two or three pouches were made for each test.

Pouches were filled through the open edge with 100±5 ml of 1:1:1 sauce (blend of equal parts by weight of ketchup, vinegar and vegetable oil). Splashing the filling onto the heat seal area was avoided as this could cause the heat seal to fail during the test. After filling, the top of the pouch was sealed in a manner that minimized air entrapment inside of the pouch. The seal integrity was inspected on all four sides of pouches to ensure that there were no flaws in the sealing that would cause the pouch to leak during the test. Any defective pouches were discarded and replaced. In some cases, flaws in the laminate were marked to identify whether new additional flaws were generated during the testing.

A pot was filled 2/3 full of water and brought to a rolling boil. The boiling pot was covered with a lid to minimize water and steam loss. The pot was observed during the test to ensure that there was enough water present to maintain boiling. The pouches were placed in the boiling water and kept there for 30 minutes. The pouches were removed and the extent of tunneling, blistering, de-lamination, or leakage was compared with any of the marked preexisting flaws. The observations were recorded. The pouches were cut open, emptied, and rinsed with soap and water. One or more 2.54 cm (one inch) strips were cut from the pouches and the laminate bond strength was measured according to the standard bond strength test described above. This was done as soon as possible after removing the pouch contents. The interiors of the pouches were examined and any other visual defects were recorded.

Test results are shown in Tables 2-4. Results are in grams force per 2.54 cm width. “B-in-b” means “Boil-in-bag.”

TABLE 2
Summary of bond strength on BOPP/BOPP

| Ex No. | 1 day | 3 days | 7 days | 14 days |
|---|---|---|---|---|
| CE 1 | 5; Not Cured | 129 ± 8; AS | 64 ± 13; AS | 66 ± 4; AS |
| CE 2 | 3; Not Cured | 307 ± 18; AS | 248 ± 19; AT | 247 ± 7; AT |
| Ex 1 | 423 ± 8; FT/AS | 416 ± 96; FT/AS | 494 ± 242; FT/AS | 392 ± 133; FT/AS |
| Ex 2 | 88 ± 17; AS | 459 ± 98; FT/AS | 581 ± 72; FT/AS | 399 ± 87; FT/AS |
| Ex 3 | 132 ± 7; AS | 539 ± 55; FT/AS | 531 ± 63; FT/AS | 462 ± 38; FT/AS |

TABLE 3
Summary of bond strength on met-BOPP/BOPP

| Ex | 1 day | 3 days | 7 days | 14 days | B-in-b |
|---|---|---|---|---|---|
| CE 1 | 5; Not Cured | 104 ± 1; AS | 88 ± 9; AF | 95 ± 15; AF | 3 ± 1; DL |
| CE 2 | 3; Not Cured | 163 ± 10; AT | 116 ± 11; AT | 85 ± 2; AT | 13 ± 4; AF |
| Ex l | 94 ± 10; AS/AT | 73 ± 6; AF | 83 ± 3; AF | 82 ± 1; AF | 9 ± 2; AF |
| Ex 3 | 61 ± 3; AS | 119 ± 17; AF/AT | 182 ± 16; AF/AT | 119 ± 14; AF | — |

TABLE 4
Summary of bond strength on Prelam/GF-19

| Ex | 1 day | 3 days | 7 days | 14 days | B-in-b |
|---|---|---|---|---|---|
| CE 1 | 54 ± 6; AS | 499 ± 7; AS | 176 ± 14; AS | 119 ± 17; AT | 3 ± 3; DL |
| CE 2 | 4; Not Cured | 367 ± 18; AS | 307 ± 20; AT | 288 ± 5; AT | 16 ± 3; AT/DL |
| Ex 1 | 313 ± 18; AT/AS | 261 ± 12; AT | 207 ± 9; AT | 216 ± 20; AT | 35 ± 10; AT/AF |

TABLE 5
Summary of bond strength on BOPP//BOPP

| Ex No. | 7 days |
|---|---|
| CE 3 | 85 ± 4; AS |
| Ex 4 | 312 ± 44; FT |
| Ex 5 | 306 ± 53; FT |

In Table 2 (showing bonding of one BOPP film to another), all the inventive examples show higher bond strength than the comparative examples at all testing times. In Table 3 (showing bonding of metalized BOPP to BOPP), Example 1 shows acceptable bond strength and boil-in-bag performance, and Example 2 shows superior bond strength at testing times of 7 and 14 days. In Table 4 (showing bonding of the aluminum surface of the Prelam to polyethylene GF-19), Example 1 showed acceptable bond strength at all testing times, and Example 1 showed boil-in-bag performance far superior to the comparative examples. In Table 5 (showing bonding of one BOPP film to another), Examples 4 and 5 show bond strength superior to the comparative examples.

1. A composition comprising one or more multifunctional isocyanate compounds and one or more polyols having structure I 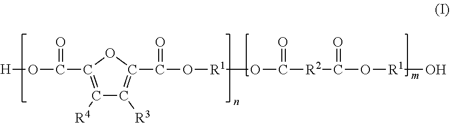
wherein each of R¹ and R² is an organic group; wherein each of R³ and R⁴ is either an organic group, a halogen atom, or a hydrogen atom; wherein n is 1 to 5,000; and
wherein m is 0 to 5,000, and wherein R² does not have the structure II

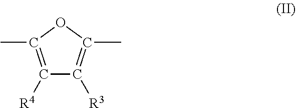

2. The composition of claim 1, wherein each of R³ and R⁴ is a hydrogen atom.

3. The composition of claim 1, wherein m is 1 to 2,000.

4. The composition of claim 1, wherein n is 2 to 2,000.

5. The composition of claim 1, wherein the composition consists of pack A and pack B, wherein pack A comprises the one or more multifunctional isocyanate compound;
wherein pack A contains polyols in an amount of zero to 5% by weight based on the weight of pack A; wherein pack B comprises the one or more compound of structure (I); wherein pack B comprises multifunctional isocyanate compounds in an amount of zero to 5% by weight based on the weight of pack B.

6. A method of adhering a first substrate to a second substrate to form an assembled article, wherein the method comprises the steps of applying a layer of the composition of claim 1 to a first surface of the first substrate and then bringing the layer of the composition of claim 1 into contact with a first surface of the second substrate.

7. The method of claim 6, wherein each of the first substrate and the second substrate is a film.

8. The method of claim 6, wherein one or both of the first surface of the first substrate or the first surface of the second substrate is metal.

9. An assembled article formed by the method of claim 6.

10. A composition comprising one or more multifunctional carboxylic acid compounds and one or more polyols having structure I 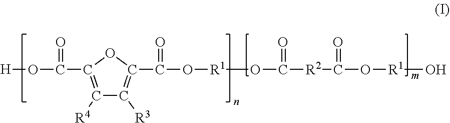
wherein each of R¹ and R² is an organic group; wherein each of R³ and R⁴ is either an organic group, a halogen atom, or a hydrogen atom; wherein n is 1 to 5,000; and
wherein m is 0 to 5,000, and wherein R² does not have the structure II

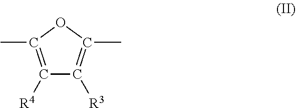

11. A method of coating a substrate to form a coated article, wherein the method comprises the steps of applying a layer of the composition of claim 10 to a surface of the substrate.
